(19) United States
(12) Patent Application Publication
(10) Pub. No.: US 2014/0095154 A1
(43) Pub. Date: Apr. 3, 2014

(54) VOICE TRANSMITTING DEVICE, VOICE TRANSMITTING METHOD, VOICE RECEIVING DEVICE, AND VOICE RECEIVING METHOD

(71) Applicant: Sony Corporation, Tokyo (JP)

(72) Inventors: Yuuki Matsumura, Saitama (JP); Shiro Suzuki, Kanagawa (JP)

(73) Assignee: Sony Corporation, Tokyo (JP)

(21) Appl. No.: 14/037,456

(22) Filed: Sep. 26, 2013

(30) Foreign Application Priority Data
Oct. 3, 2012 (JP) 2012-221744

(51) Int. Cl. G10L 19/02

(52) U.S. Cl. CPC G10L 19/02
USPC 704/205; 704/211

(57) ABSTRACT

There is provided a voice transmitting device, including a band limiting unit that performs band limitation on an input time-series signal, a coding unit that encodes a time-series signal output from the band limiting unit, a transmitting unit that transmits a code string output from the coding unit, and a control unit that controls a band limitation operation in the band limiting unit.

### BACKGROUND

The present technology relates to a voice transmitting device, a voice transmitting method, a voice receiving device, and a voice receiving method, and more particularly, to a voice transmitting device or the like which can be applied to a voice transmission system that encodes and transmits a voice signal.

In the past, voice transmission systems that encode and transmit a voice signal have been known (for example, see JP 2005-233993A). In voice coding, a bandwidth at which an input voice signal is encoded is typically decided depending on various kinds of coding schemes.

### SUMMARY

In the case of a coding scheme with a broad coding band with regard to an amount of coding information, the coding accuracy is likely to deteriorate generally, and particularly, there is a problem in that S/N sensitivity deteriorates in an audible band. Further, in the case of a coding scheme in which a variation in a coding band is allowed according to excess or deficiency in an amount of coding information, there is a problem in that particularly, S/N sensitivity of an audible band becomes unstable at the same time as band sensitivity, and thus a coding quality is not constant, and an overall quality deteriorates.

It is desirable to reliably transmit a voice signal regardless of a coding scheme.

According to an embodiment of the present technology, there is provided a voice transmitting device, including a band limiting unit that performs band limitation on an input time-series signal, a coding unit that encodes a time-series signal output from the band limiting unit, a transmitting unit that transmits a code string output from the coding unit, and a control unit that controls a band limitation operation in the band limiting unit.

According to an embodiment of the present technology, a band limiting unit performs band limitation on an input time-series signal. The band limiting unit may perform filtering on the input time-series signal through a low pass filter and obtains a band-limited time-series signal. The band limiting unit may sequentially perform a time frequency transform, a frequency spectrum operation, and a frequency time transform on the input time-series signal and obtains a band-limited time-series signal.

The coding unit encodes the time-series signal output from the band limiting unit. In this case, any scheme may be used as a coding scheme. For example, a coding scheme in which a variation in a coding band is allowed according to excess or deficiency in an amount of coding information may be used. The transmitting unit transmits the code string output from the coding unit. The transmission may be performed by any of a wireless scheme or a wired scheme.

The control unit controls the band limitation operation in the band limiting unit. For example, the control unit performs the control based on information shared with a receiving device. In this case, for example, the control unit may acquire the shared information through communication performed with the receiving device. Further, for example, the shared information may be device information, codec information, or bit rate information.

As described above, in the present technology, before encoding, band limitation is performed on the input time-series signal. Thus, in the case of a coding scheme with a broad coding band with regard to an amount of coding information, deterioration of the coding accuracy can be prevented, and S/N sensitivity of an audible band can be improved. Further, in the present technology, in the case of a coding scheme in which a variation in a coding band is allowed according to excess or deficiency in an amount of coding information, a variation in a coding band can be prevented, band sensitivity and S/N sensitivity of an audible band can be improved, a coding quality can become constant, and an overall quality can be improved.

Further, in the present technology, the band limitation operation in the band limiting unit is controlled based on information shared with the receiving device. Thus, for example, the band limiting unit can be effectively operated, and it is possible to secure synchronization with the band expansion operation in the receiving device.

In the present technology, for example, the control unit may further control the limitation start frequency in the band limiting unit based on information shared with the receiving device. For example, the control unit may acquire the shared information through communication performed with the receiving device. Further, for example, the shared information may be bit rate information or start frequency information. In this case, the limitation start frequency can be set to an effective value, and it is possible to suppress wasteful deterioration of band sensitivity. Further, it is possible to secure synchronization with the start frequency of band expansion in the receiving device.

According to another embodiment of the present technology, there is provided a voice receiving device, including a receiving unit that receives a code string, a decoding unit that decodes the code string received by the receiving unit, a band expanding unit that performs band expansion on a time-series signal output from the decoding unit, and a control unit that controls a band expansion operation in the band expanding unit based on information shared with a transmitting device.

In the present technology, the receiving unit receives the code string. The reception may be performed by any of a wireless scheme or a wired scheme. The decoding unit decodes the code string received by the receiving unit. Then, the band expanding unit performs band expansion on the time-series signal output from the decoding unit.

For example, the band expanding unit may sequentially perform band division, a sub band signal operation, and band combining on the time-series signal and obtain a band-expanded time-series signal. Further, for example, the band limiting unit may sequentially perform a time frequency transform, a frequency spectrum operation, and a frequency time transform on the time-series signal and obtain a band-expanded time-series signal.

The control unit controls the band expansion operation in the band expanding unit. For example, the control unit performs the control based on information shared with the transmitting device. In this case, for example, the control unit may acquire the shared information through communication performed with the transmitting device. Further, for example, the shared information may be device information, codec information, or bit rate information.

As described above, in the present technology, before decoding, band expansion is performed on the time-series signal. Thus, a coding quality in a limited band can become constant, an overall quality can be improved, and broad band sensitivity can be implemented. Further, in the present technology, the band expansion operation in the band expanding unit is controlled based on information shared with the transmitting device. Further, it is possible to secure synchronization with the band limitation operation in the receiving device and effectively operate the band expanding unit.

In addition, in the present technology, for example, the control unit may further control an expansion start frequency in the band expanding unit based on information shared with the transmitting device. For example, the control unit may acquire the shared information through communication performed with the transmitting device. Further, for example, the shared information may be bit rate information or start frequency information. In this case, the expansion start frequency can be set to an effective value, and it is possible to suppress wasteful deterioration of band sensitivity. Further, it is possible to secure synchronization with the start frequency of band limitation in the transmitting device.

According to embodiments of the present technology, it is possible to reliably transmit a voice signal regardless of a coding scheme.

### BRIEF DESCRIPTION OF THE DRAWINGS

FIG. 1 is a block diagram illustrating an exemplary configuration of a voice transmission system according to an embodiment;

FIGS. 2(a) and 2(b) are block diagrams illustrating exemplary configurations of a voice transmitting device and a voice receiving device of a voice transmission system according to a related art;

FIG. 3 is a block diagram illustrating an exemplary configuration of a signal coding unit configuring a voice transmitting device;

FIG. 4 is a block diagram illustrating an exemplary configuration of a signal decoding unit configuring a voice receiving device;

FIGS. 5(a) to 5(e) are diagrams for describing S/N sensitivity or band sensitivity in a voice transmission system according to a related art;

FIG. 6 is a block diagram illustrating an exemplary configuration of a voice transmitting device in a voice transmission system according to an embodiment;

FIGS. 7(a) to 7(c) are diagrams for describing an exemplary configuration of a band limiting unit configuring a voice transmitting device;

FIGS. 8(a) to 8(c) are diagrams for describing another exemplary configuration of a band limiting unit configuring a voice transmitting device;

FIG. 9 is a block diagram illustrating an exemplary configuration of a voice receiving device in a voice transmission system according to an embodiment;

FIGS. 10(a) to 10(c) are diagrams for describing an exemplary configuration of a band expanding unit configuring a voice receiving device;

FIGS. 11(a) to 11(c) are diagrams for describing another exemplary configuration of a band expanding unit configuring a voice receiving device;

FIG. 12 is a flowchart illustrating an exemplary on/off control process of band limitation and band expansion in a control unit;

FIG. 13 is a flowchart illustrating another exemplary on/off control process of band limitation and band expansion in a control unit;

FIG. 14 is a flowchart illustrating an exemplary control process of controlling both on/off band limitation and band expansion in a control unit and start frequencies of band limitation and band expansion; and

FIGS. 15(a) to 15(e) are diagrams for describing S/N sensitivity or band sensitivity in a voice transmission system according to an embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, modes (hereinafter referred to as “embodiments”) for carrying out the present technology will be described. The description will proceed in the following order:

1. Embodiment

2. Modified example

### 1. Embodiment

[Exemplary Configuration of Voice Transmission System]

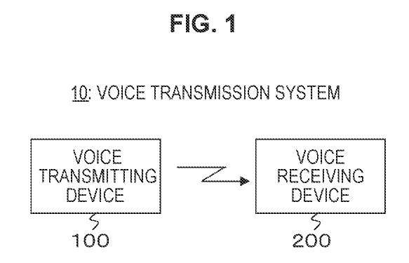

FIG. 1 illustrates an exemplary configuration of a voice transmission system 10 according to an embodiment. A voice transmission system 10 includes a voice transmitting device 100 and a voice receiving device 200. The voice transmitting device 100 encodes a voice time-series signal, and transmits an obtained code string in a wired manner or a wireless manner. The voice receiving device 200 receives a voice code string in a wired manner or a wireless manner, and decodes the received code string to obtain a time-series signal. The details of the voice transmitting device 100 and the voice receiving device 200 will be described below.

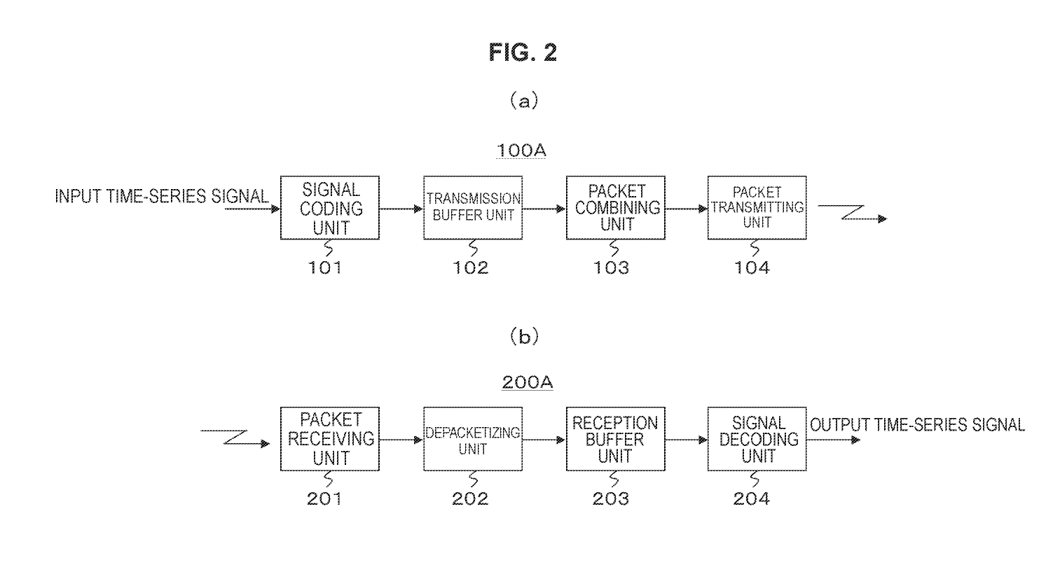

First, exemplary configurations of the voice transmitting device 100 and the voice receiving device 200 according to a related art will be described. Here, for the sake of convenience, a voice transmitting device 100A and a voice receiving device 200A will be described as the voice transmitting device 100 and the voice receiving device 200 according to the related art. FIG. 2(a) illustrates an exemplary configuration of the voice transmitting device 100A according to the related art. The voice transmitting device 100A includes a signal coding unit 101, a transmission buffer unit 102, a packet combining unit 103, and a packet transmitting unit 104. FIG. 2(b) illustrates an exemplary configuration of the voice receiving device 200A according to the related art. The voice receiving device 200A includes a packet receiving unit 201, a depacketizing unit 202, a reception buffer unit 203, and a signal decoding unit 204.

The signal coding unit 101 encodes a voice input time-series signal according to various kinds of coding schemes, and outputs a code string. The transmission buffer unit 102 buffers the code string output from the signal coding unit 101, and outputs the buffered code string. The packet combining unit 103 packetizes the buffered code string output from the transmission buffer unit 102 according to various kinds of transmission schemes, and outputs a transmission packet. The packet transmitting unit 104 transmits the transmission packet output from the packet combining unit 103 to a wired or wireless transmission path.

The packet receiving unit 201 receives the transmission packet transmitted through the wired or wireless transmission path. The depacketizing unit 202 depacketizes the transmission packet output from the packet receiving unit 201 according to various kinds of transmission schemes, and outputs a code string. The reception buffer unit 203 buffers the code string output from the depacketizing unit 202, and outputs the buffered code string. The signal decoding unit 204 decodes the buffered code string output from the reception buffer unit 203 according to various kinds of coding schemes, and outputs a time-series signal.

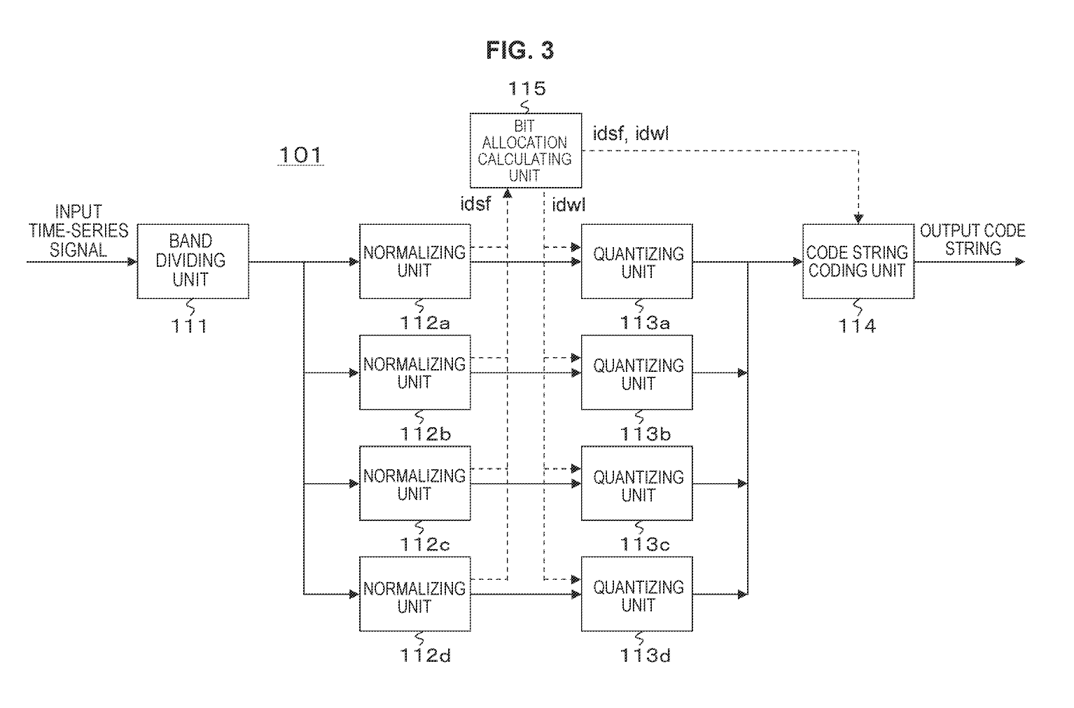

FIG. 3 illustrates an exemplary configuration of the signal coding unit 101. The signal coding unit 101 has been described above as performing encoding according to various kinds of coding schemes, and the exemplary configuration represents an example of a sub band codec (SBC) which is one of such coding schemes. The signal coding unit 101 includes a band dividing unit 111, normalizing units 112a to 112d, quantizing units 113a to 113d, a code string coding unit 114, and a bit allocation calculating unit 115.

The band dividing unit 111 performs band division on an input time-series signal such as a voice signal, and a band-divided time-series signal. For example, the band dividing unit 111 performs band division on the input time-series signal using an analysis filter such as a polyphase quadrature filter (PQF), and outputs N divided time-series signals. FIG. 3 illustrates an example in which N is 4. The normalizing units 112a to 112d normalize the time-series signals of the respective bands output from the band dividing unit 111 using a normalization coefficient according to predetermined normalization information idsf corresponding to the amplitude of the time-series signal, respectively, and output the normalization information idsf and normalized time-series signals.

The bit allocation calculating unit 115 performs bit allocation calculation for each band based on the normalization information idsf output from the normalizing units 112a to 112d and the like, and outputs quantization information idwl. The quantizing units 113a to 113d quantize the time-series signals of the respective bands output from the normalizing units 112a to 112d using a quantization coefficient corresponding to the quantization information idwl output from the bit allocation calculating unit 115, respectively, and output the quantized time-series signals. The code string coding unit 114 encodes the normalization information idsf, the quantization information idwl, the quantized time-series signals, and the like, and outputs a code string.

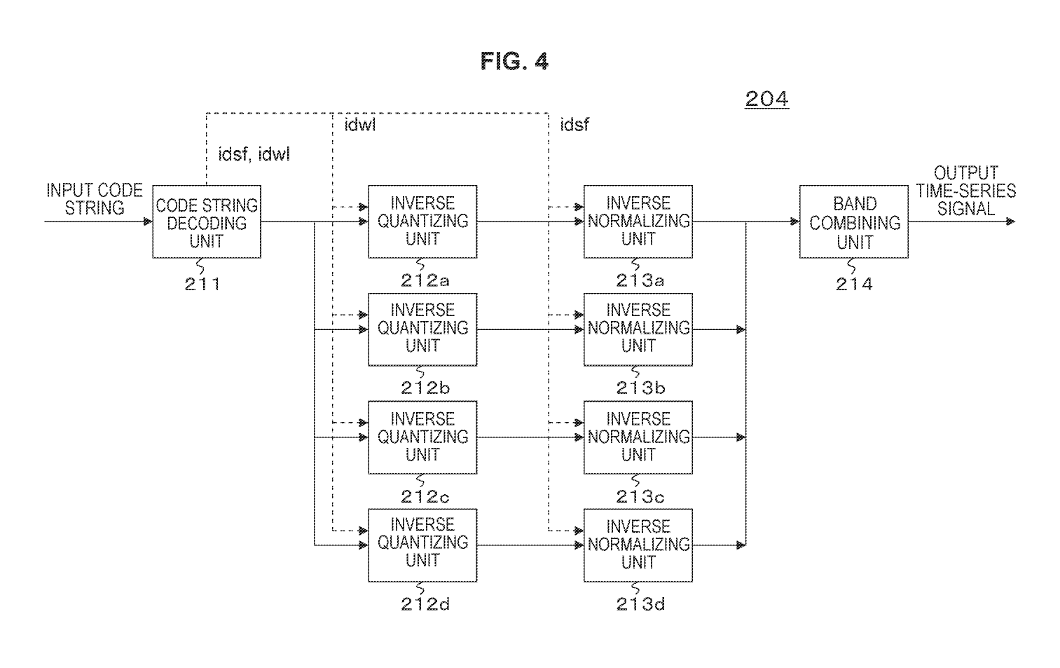

FIG. 4 illustrates an exemplary configuration of the signal decoding unit 204. The signal decoding unit 204 has been described above as performing decoding according to various kinds of coding schemes, and the exemplary configuration is a configuration corresponding to the signal coding unit 101 of FIG. 3. The signal decoding unit 204 includes a code string decoding unit 211, inverse quantizing units 212a to 212d, inverse normalizing units 213a to 213d, and a band combining unit 214.

The code string decoding unit 211 decodes an input code string, and reconstructs and outputs the normalization information idsf, the quantization information idwl, the quantized time-series signals, and the like. The inverse quantizing units 212a to 212d perform inverse quantization on the quantized time-series signals of the respective bands output from the code string decoding unit 211 using an inverse quantization coefficient corresponding to the reconstructed quantization information idwl, and output normalized time-series signals.

The inverse normalizing units 213a to 213d perform inverse normalization on the normalized time-series signals of the respective bands output from the inverse quantizing units 212a to 212d using an inverse normalization coefficient corresponding to the reconstructed normalization information idsf, and output band-divided time-series signals. The band combining unit 214 performs band combining on the band-divided time-series signals output from the inverse normalizing units 213a to 213d, and outputs a voice time-series signal. For example, the band combining unit 214 performs band combining on the N divided time-series signals using a combining filter such as an IPQF, and outputs a time-series signal.

Next, operations of the voice transmitting device 100A and the voice receiving device 200A illustrated in FIGS. 2(a) and (b) will be described. A voice input time-series signal is supplied to the signal coding unit 101. The signal coding unit 101 encodes the input time-series signal according to various kinds of coding schemes, and outputs a code string.

The code string output from the signal coding unit 101 is supplied to the transmission buffer unit 102. The transmission buffer unit 102 buffers the code string. Then, the packet combining unit 103 packetizes the code string buffered by the transmission buffer unit 102 according to various kinds of transmission schemes, and outputs a transmission packet. The transmission packet is supplied to the packet transmitting unit 104. The packet transmitting unit 104 transmits the transmission packet to the wired or wireless transmission path.

The packet receiving unit 201 receives the transmission packet transmitted through the wired or wireless transmission path. The transmission packet is supplied to the depacketizing unit 202. The depacketizing unit 202 depacketizes the transmission packet according to various kinds of transmission schemes, and outputs a code string.

The code string output from the depacketizing unit 202 is supplied to the reception buffer unit 203. The reception buffer unit 203 buffers the code string. Then, the signal decoding unit 204 decodes the code string buffered by the reception buffer unit 203 according to various kinds of coding schemes, and outputs an output time-series signal.

In the signal coding unit 101 of the voice transmitting device 100A illustrated in FIG. 2(a), a bandwidth at which the voice input time-series signal is encoded is typically decided depending on various kinds of coding schemes. For example, in the case of an SBC, a coding band is an overall band in the Nyquist frequency fn, and when a sampling frequency fs is 48 kHz, the Nyquist frequency fn is 24 kHz.

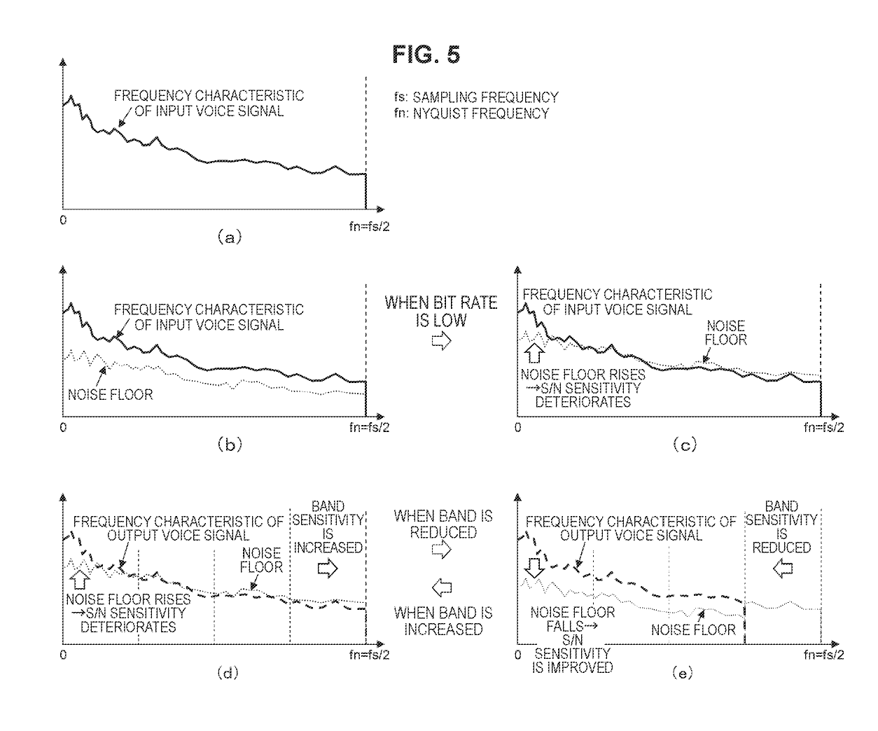

For an input voice signal (see FIG. 5(a)) having a frequency characteristic in an overall band, when a bit rate is relatively high, since an amount of coding information is sufficient, the coding accuracy is also sufficient (see FIG. 5(b)). On the other hand, when a bit rate is relatively low, since a coding band is broad with regard to an amount of coding information, the coding accuracy is likely to deteriorate generally, and particularly, as a noise floor rises in an audible band, S/N sensitivity deteriorates (see FIG. 5(c)).

Further, when an amount of coding information is deficient, for example, a coding band is adjusted, for example, in units of ⅛ of a band (3 kHz) or ¼ of a band (6 kHz). For this reason, when a band is reduced, band sensitivity is reduced, and at the same time, particularly, a noise floor falls in an audible band, and thus S/N sensitivity is improved (see FIG. 5(d)→FIG. 5(e)). However, when a band is increased, band sensitivity is increased, and at the same time, a noise floor rises in an audible band, and thus S/N sensitivity deteriorates (see FIG. 5(e)→FIG. 5(d)). For this reason, particularly, S/N sensitivity of an audible band becomes unstable at the same time as band sensitivity, and thus the coding quality is not constant, and the quality deteriorates generally.

As described above, in the case of a coding scheme with a broad coding band with regard to an amount of coding information, there is a problem in that the coding accuracy is likely to deteriorate generally, and particularly, S/N sensitivity in an audible band deteriorates. Further, in the case of a coding scheme in which a variation in a coding band is allowed according to excess or deficiency in an amount of coding information, there is a problem in that, particularly, S/N sensitivity of an audible band becomes unstable at the same time as band sensitivity, and thus a coding quality is not constant, and an overall quality deteriorates.

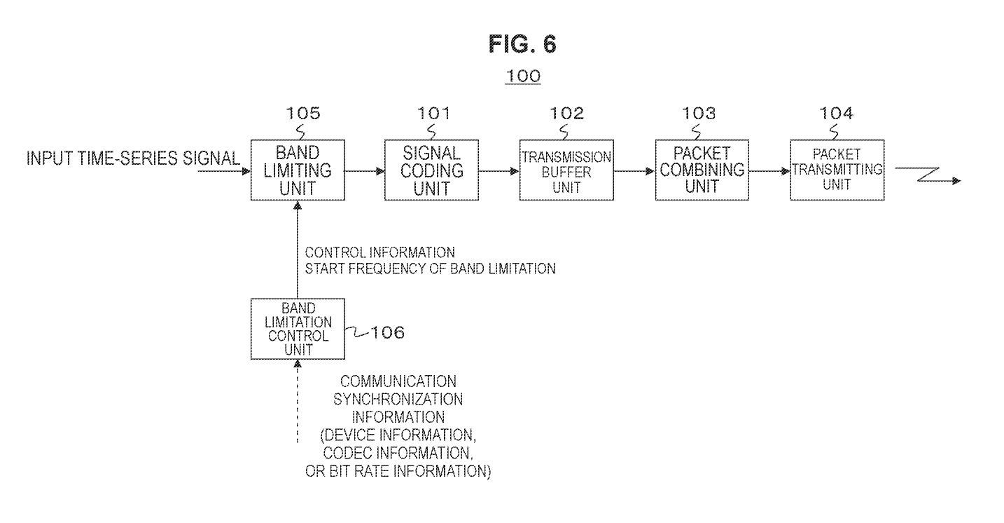

Next, the voice transmitting device 100 and the voice receiving device 200 according to the present technology will be described. FIG. 6 illustrates an exemplary configuration of the voice transmitting device 100. In FIG. 6, components corresponding to those of FIG. 2(a) are denoted by the same reference numerals, and a detailed description thereof will be appropriately omitted. The voice transmitting device 100 includes a signal coding unit 101, a transmission buffer unit 102, a packet combining unit 103, a packet transmitting unit 104, a band limiting unit 105, and a band limitation control unit 106.

The band limiting unit 105 performs band limitation on a voice input time-series signal, and outputs a band-limited time-series signal. The band limitation control unit 106 controls a band limitation operation in the band limiting unit 105, and controls a start frequency of band limitation. The voice transmitting device 100 and the voice receiving device 200 negotiate and share information with each other when establishing communication synchronization. Here, examples of shared information include device information, codec information, and bit rate information. The band limitation control unit 106 controls the band limitation operation in the band limiting unit 105 and the start frequency of band limitation based on information shared with the voice receiving device 200 as described above.

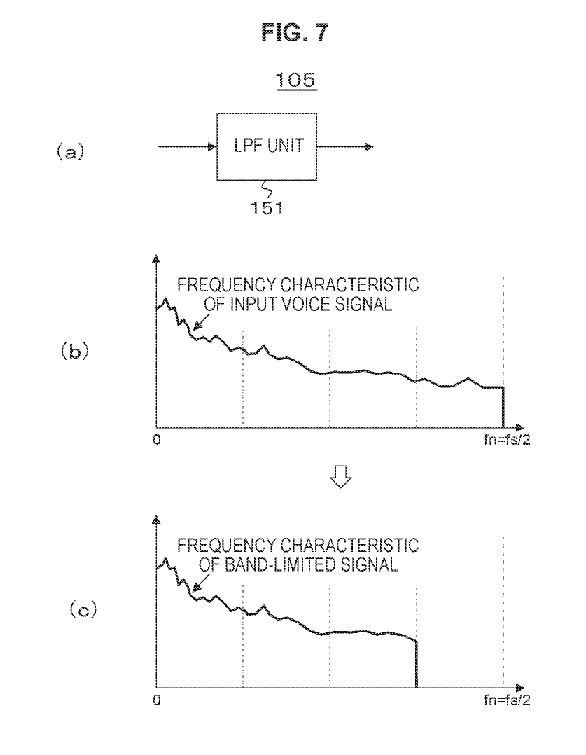

The band limiting unit 105 may have various configurations. FIG. 7(a) illustrates an exemplary configuration of the band limiting unit 105. In this exemplary configuration, the band limiting unit 105 is configured with a low pass filter unit (LPF unit) 151. In this case, the low pass filter unit 151 performs filtering on an input voice signal having a frequency characteristic in an overall band as illustrated in FIG. 7(b), and generates a band-limited voice signal as illustrated in FIG. 7(c).

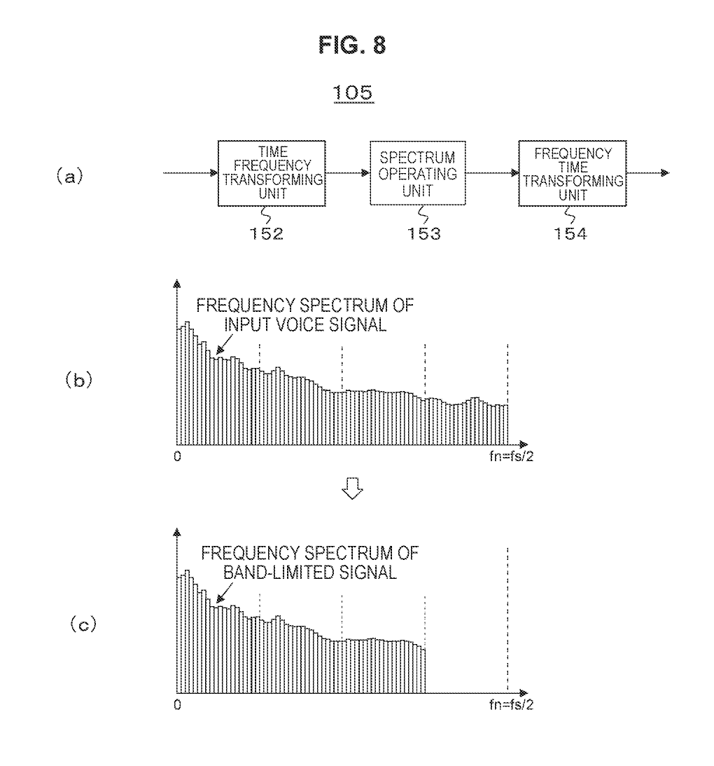

FIG. 8(a) illustrates another exemplary configuration of the band limiting unit 105. In this exemplary configuration, the band limiting unit 105 is configured with a series circuit of a time frequency transforming unit 152, a spectrum operating unit 153, and a frequency time transforming unit 154. The time frequency transforming unit 152 performs a time frequency transform such as a discrete Fourier transform (DFT). The spectrum operating unit 153 performs band limitation by a frequency spectrum operation on a frequency axis. The frequency time transforming unit 154 performs a frequency time transform such as an inverse discrete Fourier transform (IDFT). In this case, the band limitation by the frequency spectrum operation is performed on a frequency spectrum having a frequency characteristic in an overall band as illustrated in FIG. 8(b), and a frequency spectrum of a band-limited voice signal is generated as illustrated in FIG. 8(c).

Referring back to FIG. 6, the signal coding unit 101 encodes the voice time-series signal output from the band limiting unit 105 according to various kinds of coding schemes, and outputs a code string. The transmission buffer unit 102 buffers the code string output from the signal coding unit 101, and outputs a buffered code string. The packet combining unit 103 packetizes the buffered code string output from the transmission buffer unit 102 according to various kinds of transmission schemes, and outputs a transmission packet. The packet transmitting unit 104 transmits the transmission packet output from the packet combining unit 103 to a wired or wireless transmission path.

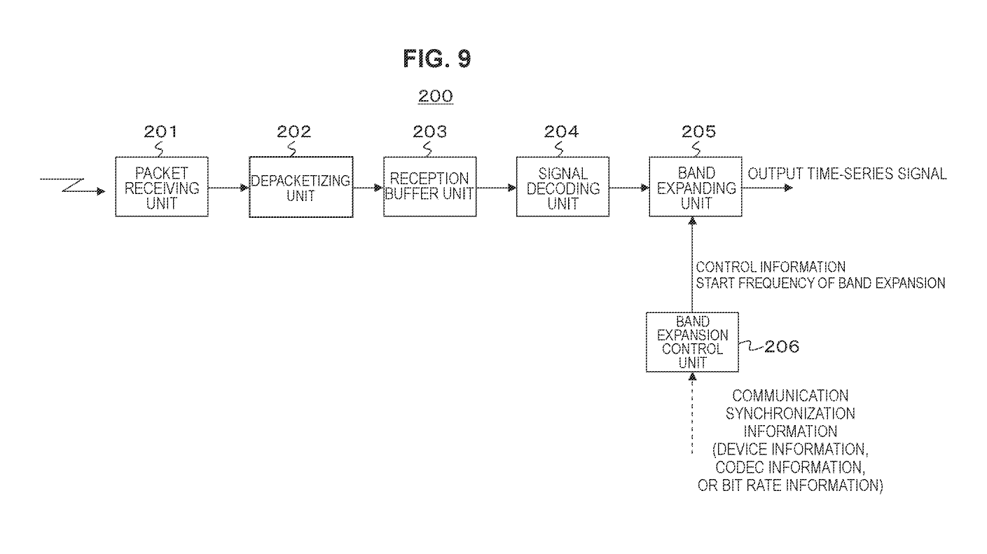

FIG. 9 illustrates an exemplary configuration of the voice receiving device 200. In FIG. 9, components corresponding to those of FIG. 2(b) are denoted by the same reference numerals, and a detailed description thereof will be appropriately omitted. The voice receiving device 200 includes a packet receiving unit 201, a depacketizing unit 202, a reception buffer unit 203, a signal decoding unit 204, a band expanding unit 205, and a band expansion control unit 206.

The packet receiving unit 201 receives a transmission packet transmitted through the wired or wireless transmission path. The depacketizing unit 202 depacketizes the transmission packet output from the packet receiving unit 201 according to various kinds of transmission schemes, and outputs a code string. The reception buffer unit 203 buffers the code string output from the depacketizing unit 202, and outputs the buffered code string. The signal decoding unit 204 decodes the buffered code string output from the reception buffer unit 203 according to various kinds of coding schemes, and outputs a time-series signal.

The band expanding unit 205 performs band expansion on the voice time-series signal output from the signal decoding unit 204, and outputs a band-expanded voice output time-series signal. The band expansion control unit 206 controls the band expansion operation in the band expanding unit 205, and controls a start frequency of band expansion. As described above, when establishing communication synchronization, the voice transmitting device 100 and the voice receiving device 200 negotiate share information such as device information, codec information, and bit rate information with each other. The band expansion control unit 206 controls the band expansion operation in the band expanding unit 205 and the start frequency of band expansion based on the information shared with the voice transmitting device 100 as described above.

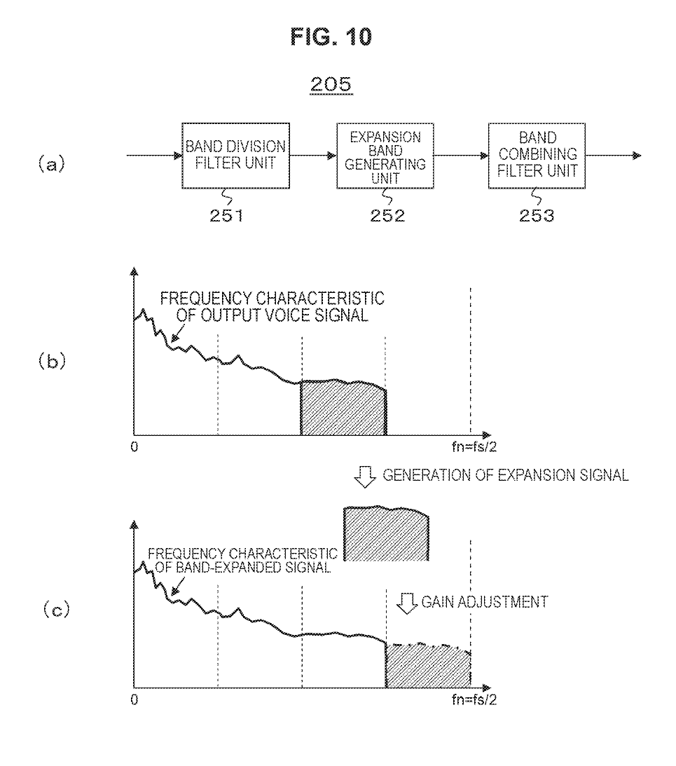

The band expanding unit 205 may have various configurations. For example, JP 2008-139844A discloses a band expansion technique. FIG. 10(a) illustrates an exemplary configuration of the band expanding unit 205. In this exemplary configuration, the band expanding unit 205 is configured with a series circuit of a band division filter unit 251, an expansion band generating unit 252, and a band combining filter unit 253.

The band division filter unit 251 performs a band division filter process of a PQF or the like. The expansion band generating unit 252 performs band expansion by generation of an expansion signal and gain adjustment based on a sub band signal on a time axis. The band combining filter unit 253 performs a band combining filter process of an IPQF or the like. In this case, generation of an expansion signal and gain adjustment based on a sub band signal are performed on a band-limited voice signal as illustrated in FIG. 10(b), and a band-expanded voice signal is generated as illustrated in FIG. 10(c).

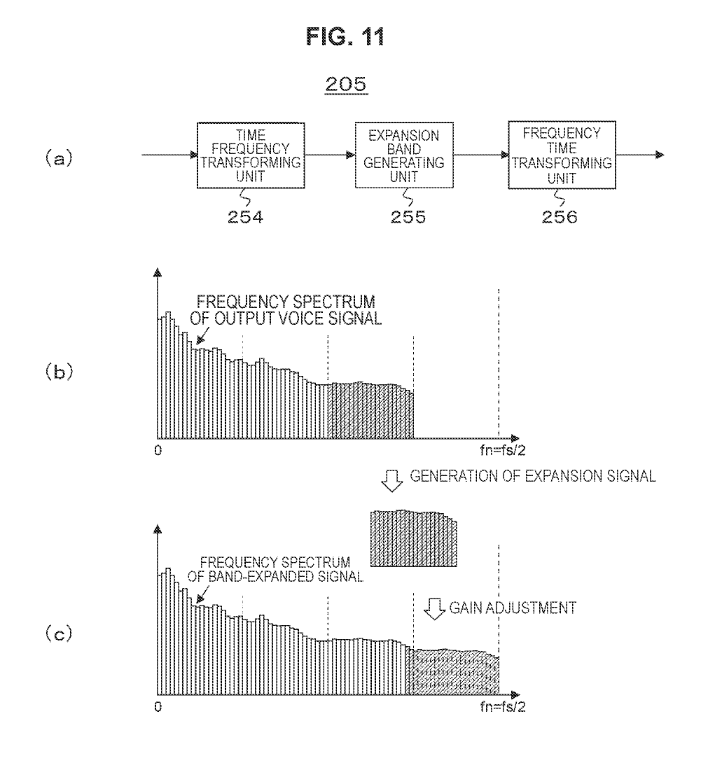

FIG. 11(a) illustrates another exemplary configuration of the band expanding unit 205. In this exemplary configuration, the band expanding unit 205 is configured with a series circuit of a time frequency transforming unit 254, an expansion band generating unit 255, and a frequency time transforming unit 256. The time frequency transforming unit 254 performs a time frequency transform such as a DFT. The expansion band generating unit 255 performs band expansion by generation of an expansion signal and gain adjustment based on a frequency spectrum on a frequency axis. The frequency time transforming unit 256 performs a frequency time transform such as an IDFT. In this case, band expansion by generation of an expansion signal and gain adjustment based on a frequency spectrum are performed on a frequency spectrum of a band-limited voice signal as illustrated in FIG. 11(b), and a frequency spectrum of a band-expanded voice signal is generated as illustrated in FIG. 11(c).

Next, operations of the voice transmitting device 100 and the voice receiving device 200 illustrated in FIGS. 6 and 9 will be described. The voice input time-series signal is supplied to the band limiting unit 105. The band limiting unit 105 performs band limitation on the voice input time-series signal when the band limitation operation is turned on. The time-series signal output from the band limiting unit 105 is supplied to the signal coding unit 101.

The signal coding unit 101 encodes the time-series signal according to various kinds of coding schemes, and outputs a code string. The code string is supplied to the transmission buffer unit 102. The transmission buffer unit 102 buffers the code string. Then, the packet combining unit 103 packetizes the code string buffered by the transmission buffer unit 102 according to various kinds of transmission schemes, and outputs a transmission packet. The transmission packet is supplied to the packet transmitting unit 104. The packet transmitting unit 104 transmits the transmission packet to the wired or wireless transmission path.

The packet receiving unit 201 receives the transmission packet transmitted through the wired or wireless transmission path. The transmission packet is supplied to the depacketizing unit 202. The depacketizing unit 202 depacketizes the transmission packet according to various kinds of transmission schemes, and outputs a code string.

The code string output from the depacketizing unit 202 is supplied to the reception buffer unit 203. The reception buffer unit 203 buffers the code string. Then, the signal decoding unit 204 decodes the code string buffered by the reception buffer unit 203 according to various kinds of coding schemes, and outputs a voice time-series signal. The time-series signal is supplied to the band expanding unit 205. The band expanding unit 205 performs band expansion on the voice time-series signal when the band expansion operation is turned on. The time-series signal output from the band expanding unit 205 is an output time-series signal.

The control process in the band limitation control unit 106 of the voice transmitting device 100 and the band expansion control unit 206 of the voice receiving device 200 will be further described. Hereinafter, the band limitation control unit 106 and the band expansion control unit 206 are referred to simply as a “control unit.”

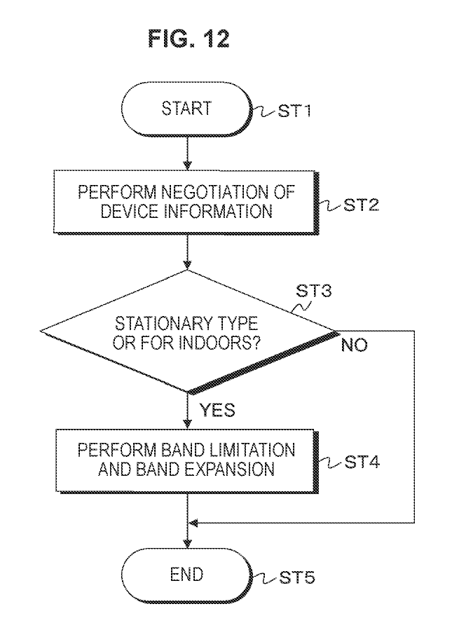

A flowchart of FIG. 12 illustrates an exemplary on/off control process of band limitation and band expansion in the control unit. In step ST1, the control unit starts the control process and then causes the process to proceed to step ST2. In step ST2, the control unit performs negotiation of device information, and so the device information is shared between a transmission side and a reception side.

Next, in step ST3, the control unit determines whether or not the voice receiving device 200 is of a stationary type or for indoors. Here, when the voice receiving device 200 is of a stationary type or for indoors, since it is easy to detect deterioration of the coding quality, control can be performed such that band limitation and band expansion are performed on an input time-series signal and an output time-series signal, respectively. However, when the voice receiving device 200 is of a portable type or for outdoors, since it is not easy to detect deterioration of the coding quality, control can be performed such that band limitation and band expansion are not performed on an input time-series signal and an output time-series signal, respectively.

When it is determined that the voice receiving device 200 is of a stationary type or for indoors, in step ST4, the control unit performs band limitation and band expansion. In other words, the band limitation operation of the band limiting unit 105 in the voice transmitting device 100 is turned on, and the band expansion operation of the band expanding unit 205 in the voice receiving device 200 is turned on. After step ST4, in step ST5, the control unit ends the process. Further, when it is determined in step ST3 that the voice receiving device 200 is of a portable type or for outdoors, the control unit immediately causes the process to proceed to step ST5, and ends the process. At this time, the band limitation operation of the band limiting unit 105 in the voice transmitting device 100 is turned off, and the band expansion operation of the band expanding unit 205 in the voice receiving device 200 is turned off.

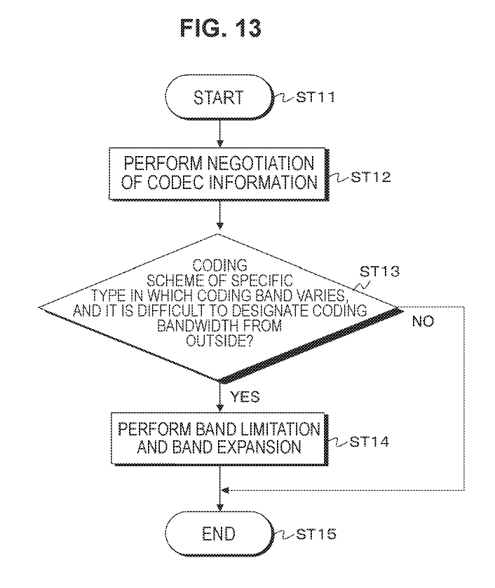

A flowchart of FIG. 13 illustrates another exemplary on/off control process of band limitation and band expansion in the control unit. In step ST11, the control unit starts the control process and then causes the process to proceed to step ST12. In step ST12, the control unit performs negotiation of codec information, and so the codec information is shared between a transmission side and a reception side.

Next, in step ST13, the control unit determines whether or not a coding scheme (codec) to be used is a coding scheme (for example, SBC) of a specific type in which a coding band varies, and it is difficult to designate a coding bandwidth from the outside. When it is determined that the coding scheme (codec) to be used is the coding scheme of the specific type, control can be performed such that band limitation and band expansion are performed on an input time-series signal and an output time-series signal, respectively. However, when it is determined that the coding scheme (codec) to be used is not the coding scheme of the specific type, control can be performed such that band limitation and band expansion are not performed on an input time-series signal and an output time-series signal, respectively.

When it is determined in step ST13 that the coding scheme (codec) to be used is the coding scheme of the specific type, in step ST14, the control unit performs band limitation and band expansion. In other words, the band limitation operation of the band limiting unit 105 in the voice transmitting device 100 is turned on, and the band expansion operation of the band expanding unit 205 in the voice receiving device 200 is turned on. After step ST14, in step ST15, the control unit ends the process. Further, when it is determined in step ST13 that the coding scheme (codec) to be used is not the coding scheme of the specific type, the control unit immediately causes the process to proceed to step ST15, and ends the process. At this time, the band limitation operation of the band limiting unit 105 in the voice transmitting device 100 is turned off, and the band expansion operation of the band expanding unit 205 in the voice receiving device 200 is turned off.

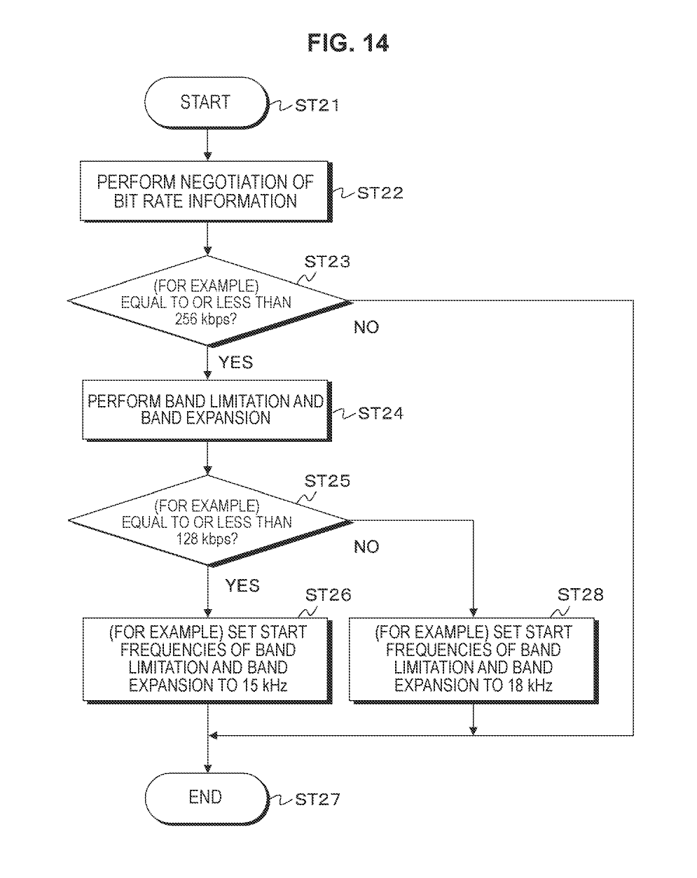

A flowchart of FIG. 14 illustrates an exemplary control process of controlling both on/off of band limitation and band expansion and the start frequencies of band limitation and band expansion in the control unit. In step ST21, the control unit starts the control process and then causes the process to proceed to step ST22. In step ST22, the control unit performs negotiation of bit rate information, and so the bit rate information is shared between a transmission side and a reception side.

Next, in step ST23, the control unit determines whether the bit rate of a coding scheme (codec) to be used is low, for example, equal to or less than 256 kbps. When the bit rate is high, since a sufficient amount of coding information is given, control can be performed such that band limitation and band expansion are not performed on an input time-series signal and an output time-series signal, respectively. However, when the bit rate is low, since a sufficient amount of coding information is not given, control can be performed such that band limitation and band expansion are performed on an input time-series signal and an output time-series signal, respectively.

When it is determined in step ST23 that the bit rate is equal to or less than 256 kbps, in step ST24, the control unit performs band limitation and band expansion. In other words, the band limitation operation of the band limiting unit 105 in the voice transmitting device 100 is turned on, and the band expansion operation of the band expanding unit 205 in the voice receiving device 200 is turned on. After step ST24, the control unit causes the process to proceed to step ST25.

For example, in step ST25, the control unit determines that the bit rate is equal to or less than 128 kbps. When the bit rate is equal to or less than 128 kbps, in step ST26, the control unit sets the start frequencies of band limitation and band expansion to, for example, 15 kHz, then causes the process to proceed to step ST27, and thus the process ends. When it is determined in step ST25 that the bit rate is neither equal to nor less than 128 kbps, in step ST28, the control unit sets the start frequencies of band limitation and band expansion to, for example, 18 kHz, then causes the process to proceed to step ST27, and thus the process ends.

Meanwhile, when it is determined in step ST23 that the bit rate is neither equal to nor less than 256 kbps, the control unit causes the process to proceed to step ST27 and then ends the process. At this time, the band limitation operation of the band limiting unit 105 in the voice transmitting device 100 is turned off, and the band expansion operation of the band expanding unit 205 in the voice receiving device 200 is turned off. Of course, at this time, it is unnecessary to set start frequencies of band limitation and band expansion.

The start frequencies of band limitation and band expansion can be set based on bit rate information as illustrated in the flowchart of FIG. 14 and may be set based on start frequency information which is shared between the transmission side and the reception side, for example, through negotiation of start frequency information performed by the control unit. Further, the start frequency may be a fixed value which is set in advance.

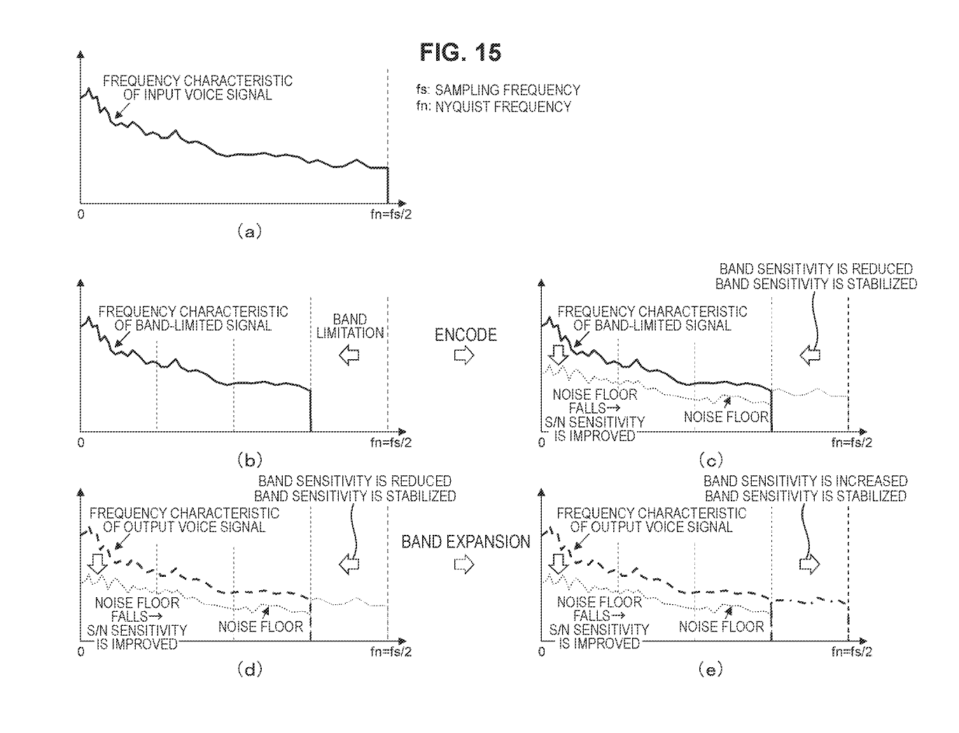

As described above, in the voice transmitting device 100 illustrated in FIG. 6 the band limiting unit 105 performs band limitation on an input voice signal having a frequency characteristic in an overall band as illustrated in FIG. 15(a) and generates a band-limited voice signal as illustrated in FIG. 15(b). Then, the signal coding unit 101 encodes the band-limited signal, and generates a code string.

Thus, as illustrated in FIG. 15(c), band sensitivity can be reduced and stabilized, and at the same time, as a noise floor falls, S/N sensitivity can be improved. Thus, in the case of a coding scheme with a broad coding band with regard to an amount of coding information, since band limitation is performed on an input voice signal, deterioration of the coding accuracy can be prevented, and particularly, S/N sensitivity in an audible band can be improved. Further, in the case of a coding scheme in which a variation in a coding band is allowed according to excess or deficiency in an amount of coding information, a variation in a coding band can be prevented, band sensitivity can be stabilized, particularly, S/N sensitivity in an audible band can be improved, and thus a coding quality is constant, and an overall quality can be improved.

Further, in the voice receiving device 200 illustrated in FIG. 9, a band-limited voice signal is obtained from the signal decoding unit 204 as illustrated in FIG. 15(d). In the voice signal, band sensitivity is reduced and stabilized as described above, and at the same time, as a noise floor falls, S/N sensitivity is improved. As the band expanding unit 205 performs band expansion on the voice signal, band sensitivity reduced by band limitation can be increased as illustrated in FIG. 15(e). Thus, through collaboration of the voice transmitting device 100 and the voice receiving device 200, a coding quality in a limited band can become constant, an overall quality can be improved, and broad band sensitivity can be implemented.

Further, in the voice transmitting device 100 illustrated in FIG. 6 and the voice receiving device 200 illustrated in FIG. 9, when communication synchronization is established, negotiation is performed, and information such as device information, codec information, and bit rate information is shared. Then, control of the band limitation operation and the band expansion operation in the band limiting unit 105 and the band expanding unit 205 and control of the start frequencies of band limitation and band expansion are performed based on the shared information. Thus, it is possible to secure synchronization of the band limitation operation and the band expansion operation of the band limiting unit 105 and the band expanding unit 205, it is possible to match start frequencies of band limitation and band expansion, and it is possible to effectively operate the band limiting unit 105 and the band expanding unit 205.

### 2. Modified Example

The above embodiment has been described in connection with the example in which the voice transmitting device 100 performs band limitation and the voice receiving device 200 performs band expansion. However, when the voice transmitting device 100 performs band limitation, the voice receiving device 200 need not necessarily perform band expansion. The above-described effects can be obtained even when only band limitation is performed through the voice transmitting device 100.

Further, the above embodiment has been described in connection with the example in which the voice transmitting device 100 and the voice receiving device 200 perform communication and share information with each other. However, for example, information may be shared between the devices such that information is input by a user.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) A voice transmitting device, including:

a band limiting unit that performs band limitation on an input time-series signal;

a coding unit that encodes a time-series signal output from the band limiting unit;

a transmitting unit that transmits a code string output from the coding unit; and

a control unit that controls a band limitation operation in the band limiting unit.

(2) The voice transmitting device according to (1),

wherein the control unit controls the band limitation operation in the band limiting unit based on information shared with a receiving device.

(3) The voice transmitting device according to (2),

wherein the control unit acquires the shared information through communication performed with the receiving device.

(4) The voice transmitting device according to (2) or (3),

wherein the shared information is any one of device information, codec information, and bit rate information.

(5) The voice transmitting device according to any one of (2) to (4),

wherein the control unit further controls a limitation start frequency in the band limiting unit based on information shared with the receiving device.

(6) The voice transmitting device according to (5),

wherein the control unit acquires the shared information through communication performed with the receiving device.

(7) The voice transmitting device according to (5) or (6),

wherein the shared information is any one of bit rate information and start frequency information.

(8) The voice transmitting device according to any one of (1) to (7),

wherein the band limiting unit performs filtering on the input time-series signal through a low pass filter and obtains a band-limited time-series signal.

(9) The voice transmitting device according to any one of (1) to (7),

wherein the band limiting unit sequentially performs a time frequency transform, a frequency spectrum operation, and a frequency time transform on the input time-series signal and obtains a band-limited time-series signal.

(10). A voice transmitting method, including:

performing band limitation on an input time-series signal;

encoding a time-series signal obtained in the band limitation step;

packetizing and transmitting a code string obtained in the encoding step; and

controlling a band limitation operation in the band limitation step.

(11) A voice receiving device, including:

a receiving unit that receives a code string;

a decoding unit that decodes the code string received by the receiving unit;

a band expanding unit that performs band expansion on a time-series signal output from the decoding unit; and

a control unit that controls a band expansion operation in the band expanding unit based on information shared with a transmitting device.

(12) The voice receiving device according to (11),

wherein the control unit controls the band expansion operation in the band expanding unit based on information shared with a transmitting device.

(13) The voice receiving device according to (12),

wherein the control unit acquires the shared information through communication performed with the transmitting device.

(14) The voice receiving device according to (12) or (13),

wherein the shared information is any one of device information, codec information, and bit rate information.

(15) The voice receiving device according to any one of (12) to (14),

wherein the control unit further controls an expansion start frequency in the band expanding unit based on information shared with the transmitting device.

(16) The voice receiving device according to (15),

wherein the control unit acquires the shared information through communication performed with the transmitting device.

(17) The voice receiving device according to (15) or (16),

wherein the shared information is any one of bit rate information and start frequency information.

(18) The voice receiving device according to any one of (11) to (17),

wherein the band expanding unit sequentially performs band division, a sub band signal operation, and band combining on the time-series signal, and obtains a band-expanded time-series signal.

(19) The voice receiving device according to any one of (11) to (17),

wherein the band limiting unit sequentially performs a time frequency transform, a frequency spectrum operation, and a frequency time transform on the time-series signal, and obtains a band-expanded time-series signal.

(20) A voice receiving method, including:

receiving a code string;

decoding the code string received in the receiving step;

performing band expansion on the time-series signal obtained in the decoding step; and

controlling a band expansion operation in the band expansion step.

The present disclosure contains subject matter related to that disclosed in Japanese Priority Patent Application JP 2012-221744 filed in the Japan Patent Office on Oct. 3, 2012, the entire content of which is hereby incorporated by reference.

What is claimed is:

1. A voice transmitting device, comprising:
a band limiting unit that performs band limitation on an input time-series signal;
a coding unit that encodes a time-series signal output from the band limiting unit;
a transmitting unit that transmits a code string output from the coding unit; and
a control unit that controls a band limitation operation in the band limiting unit.

2. The voice transmitting device according to claim 1,
wherein the control unit controls the band limitation operation in the band limiting unit based on information shared with a receiving device.

3. The voice transmitting device according to claim 2,
wherein the control unit acquires the shared information through communication performed with the receiving device.

4. The voice transmitting device according to claim 2,
wherein the shared information is any one of device information, codec information, and bit rate information.

5. The voice transmitting device according to claim 2,
wherein the control unit further controls a limitation start frequency in the band limiting unit based on information shared with the receiving device.

6. The voice transmitting device according to claim 5,
wherein the control unit acquires the shared information through communication performed with the receiving device.

7. The voice transmitting device according to claim 5,
wherein the shared information is any one of bit rate information and start frequency information.

8. The voice transmitting device according to claim 1,
wherein the band limiting unit performs filtering on the input time-series signal through a low pass filter and obtains a band-limited time-series signal.

9. The voice transmitting device according to claim 1,
wherein the band limiting unit sequentially performs a time frequency transform, a frequency spectrum operation, and a frequency time transform on the input time-series signal and obtains a band-limited time-series signal.

10. A voice transmitting method, comprising:
performing band limitation on an input time-series signal;
encoding a time-series signal obtained in the band limitation step;
packetizing and transmitting a code string obtained in the encoding step; and
controlling a band limitation operation in the band limitation step.

11. A voice receiving device, comprising:
a receiving unit that receives a code string;
a decoding unit that decodes the code string received by the receiving unit;
a band expanding unit that performs band expansion on a time-series signal output from the decoding unit; and
a control unit that controls a band expansion operation in the band expanding unit based on information shared with a transmitting device.

12. The voice receiving device according to claim 11,
wherein the control unit controls the band expansion operation in the band expanding unit based on information shared with a transmitting device.

13. The voice receiving device according to claim 12,
wherein the control unit acquires the shared information through communication performed with the transmitting device.

14. The voice receiving device according to claim 12,
wherein the shared information is any one of device information, codec information, and bit rate information.

15. The voice receiving device according to claim 12,
wherein the control unit further controls an expansion start frequency in the band expanding unit based on information shared with the transmitting device.

16. The voice receiving device according to claim 15,
wherein the control unit acquires the shared information through communication performed with the transmitting device.

17. The voice receiving device according to claim 15,
wherein the shared information is any one of bit rate information and start frequency information.

18. The voice receiving device according to claim 11,
wherein the band expanding unit sequentially performs band division, a sub band signal operation, and band combining on the time-series signal, and obtains a band-expanded time-series signal.

19. The voice receiving device according to claim 11,
wherein the band limiting unit sequentially performs a time frequency transform, a frequency spectrum operation, and a frequency time transform on the time-series signal, and obtains a band-expanded time-series signal.

20. A voice receiving method, comprising:
receiving a code string;
decoding the code string received in the receiving step;
performing band expansion on the time-series signal obtained in the decoding step; and
controlling a band expansion operation in the band expansion step.
